(19) United States
(12) Patent Application Publication
(10) Pub. No.: US 2026/0196903 A1
(43) Pub. Date: Jul. 9, 2026

(54) Fan motor silent at high speed

(71) Applicant: DONGGUAN CHI DRIVE MOTORS CO.,LTD, Dongguan (CN)

(72) Inventors: Tianyou Cao, Yiyang (CN); Zhenjian Zhang, Jiangmen (CN)

(21) Appl. No.: 19/133,153

(22) PCT Filed: Jan. 5, 2023
(86) PCT No.: PCT/CN2023/070757

§ 371 Date: May 27, 2025

(30) Foreign Application Priority Data
Dec. 21, 2022 (CN) 202211645494.X

(51) Int. Cl. F04D 25/06; F04D 29/056; H02K 5/173; H02K 7/14

(52) U.S. Cl. CPC H02K 7/14; H02K 5/1732; F04D 25/0606; F04D 29/056

(57) ABSTRACT

A fan motor silent at a high speed includes a casing, a rotor, a stator assembly and a bearing support. The stator assembly and the bearing support are sequentially and coaxially nested and fixed in the casing, a first bearing and a second bearing are coaxially mounted at two ends of the bearing support, inner iron cores are inlaid in the bearing support at intervals, two ends of the rotor are mounted on the first bearing and the second bearing, and a through air duct is arranged between an outer wall of the stator assembly and an inner wall of the casing. The first bearing and the second bearing and mounted integrally and coaxially, such that vibrations generated during high-speed rotation of the rotor are small, and force borne by the bearings is uniform, thus improving the silencing effect in operation of the motor.

### BACKGROUND OF THE INVENTION

### Technical Field

The invention relates to the technical field of motors, in particular to a fan motor silent at a high speed.

### Description of Related Art

It is commonly known that existing high-speed fan motors have an extremely high speed (over hundreds of thousands of RPM) in operation, thereby having an extremely high requirement for the dynamic balance precision of rotors.

At present, bearings of existing high-speed fan motors are generally mounted between an impeller and a magnetic ring, and with the two bearings as support points, a cantilever beam structure is formed by the bearings and the magnetic ring. However, due to the limitation of the dimensional accuracy of the magnetic ring and the installation process of the magnetic ring and the bearings, a great imbalance is caused by the magnetic ring and the bearings, leading to vibrations and noise in high-speed operation. In the cantilever beam structure formed by such a bearing arrangement structure, a large radial force will be applied to the two bearings under the action of the vibrations, and the bearings will be easily damaged in long-term operation. According to another bearing arrangement structure, bearings are arranged on two sides of a magnetic ring, and a simply supported beam structure is formed by the bearings and the magnetic ring. Such a structure effectively restrains vibrations and noise produced by an imbalance of the magnetic ring. However, at present, in such a structure, the bearings are fixed generally by means of front and rear end covers, and under the influence of the assembly tolerance of the front and rear end covers, the concentricity of the front and rear bearings is poor. For example, Chinese Invention Patent Publication No. CN201921475028.5 discloses a high-speed fan motor, wherein a stator is mounted at the tail of a casing, so the concentricity of a first bearing, a second bearing and a third bearing after assembly is poor, and the bearings are easily damaged in long-term operation, producing noise. In addition, wires of existing stator windings are often rotated to be wound, and the space in the stator windings is extremely narrow, so the winding speed is low, greatly compromising the production efficiency of motor stators. In view of these obvious defects, a fan motor silent at a high speed is provided to solve the aforesaid problems.

### BRIEF SUMMARY OF THE INVENTION

In view of the defects in the prior art, the goal of the invention is to provide a fan motor silent at a high speed.

To fulfill the above goal, the invention adopts the following technical solution:

A fan motor silent at a high speed includes a casing, a rotor, a stator assembly and a hollow bearing support. The stator assembly and the bearing support are sequentially and coaxially nested and fixed in the casing, a first bearing and a second bearing are coaxially mounted at two ends of the bearing support, inner iron cores are inlaid in the bearing support at intervals, two ends of the rotor are rotatably inserted into inner holes of the first bearing and the second bearing respectively, a through air duct is arranged between an outer wall of the stator assembly and an inner wall of the casing, an impeller opposite to the air duct in position is fixedly mounted at an exposed end of the rotor and located in the casing, and air guide vanes which are distributed in an axial direction of the rotor and incline in a same direction are arranged on an inner wall of the air duct at intervals.

Preferably, the stator assembly includes at least two winding assemblies which are connected and spliced in a circular shape; and each winding assembly includes an arc-shaped insulating support, a winding and an outer iron core, the winding is fixedly mounted on the insulating support, the outer iron core is inlaid in the insulating support, and the outer iron core has an end penetrating through an inner hole of the winding and exposed to an outer surface of the insulating support.

Preferably, a positioning groove used for mounting the winding is formed in the insulating support.

Preferably, each inner iron core has two ends exposed to an inner wall and an outer surface of the bearing support, and the outer iron core has an end attached to one end of the corresponding inner iron core.

Preferably, the outer iron cores and the inner iron cores are all T-shaped, and narrow ends of the outer iron cores are attached to narrow ends of the inner iron cores.

Preferably, a deformation portion is connected between every two adjacent outer iron cores, and a deformation groove and a material-reduction groove are formed in an upper end and a lower end of the deformation portion respectively.

Preferably, a pin electrically connected to the winding is arranged at an end of the insulating support, and a terminal circuit board is soldered to the pin.

Preferably, a Y-shaped protection pillar is arranged at an end of the insulating support, and an end of the pin is inlaid in the protection pillar.

Preferably, limiting grooves are coaxially formed in two ends of the bearing support, and the first bearing and the second bearing are fixedly mounted in the limiting grooves with glue.

Preferably, the bearing support and the inner iron core are formed integrally by injection molding with a mold, and the two limiting grooves are formed synchronously after injection molding with the mold.

By adopting the above technical solution, compared with the prior art, the invention has the following obvious advantages and beneficial effects:
1. First, the first bearing and the second bearing are coaxially and integrally mounted at the two ends of the bearing support, such that the coaxiality and concentricity of the first bearing and the second bearing after installation are greatly reduced; the two ends of the rotor are rotatably inserted into the inner holes of the first bearing and the second bearing, such that the rotor is always in a dynamic balance state during high-speed rotation, thus effectively reducing vibrations generated during high-speed rotation of the rotor and lowering noise produced in operation of the fan motor; in addition, the two ends of the rotor are uniformly supported by the first bearing and the second bearing, and an installation structure of a cantilever beam of the rotor is effectively avoided, such that force is uniformly applied to the first bearing and the second bearing, and a radial force applied to the two bearings during rotation of the rotor is effectively prevented, thus greatly prolonging the service life of the first bearing and the second bearing.
2. Second, the bearing support and the inner iron cores are integrally formed by injection molding with a mold, and the two limiting grooves for fixing the first bearing and the second bearing are formed synchronously after injection molding with the mold, such that the concentricity of the two limiting grooves is guaranteed, and the concentricity of a center line formed by the two limiting grooves and the inner iron cores is effectively improved, thus greatly improving the manufacturing precision of the stator assembly.
3. Moreover, after a plurality of winding assemblies of the stator assembly are unfolded horizontally, the windings may be sequentially wound in the positioning grooves, such that the operation space for winding is effectively enlarged after the winding assemblies are horizontally unfolded; in addition, wires of stator windings are sequentially and horizontally rotated to be wound rather than being rotated from top to bottom to be inserted to be wound, such that the winding efficiency of the windings is greatly improved, the winding time is shortened, and the production efficiency is improved.
4. Finally, the first bearing and the second bearing are integrally mounted on the bearing support, the rotor is mounted between the first bearing and the second bearing, the first bearing and the second bearing are synchronously mounted on the bearing support, the stator assembly is coaxially mounted on the circumferential surface of the bearing support, and the stator assembly together with the bearing support and the rotor is mounted in the casing, such that the assembly tolerance of the first bearing and the second bearing is effectively reduced, the concentricity of the first bearing and the second bearing is improved, and in a case where the rotor rotates at a high speed for a long time, the first bearing and the second bearing may rotate coaxially and smoothly to be protected against damage during high-speed operation, and noise produced during high-speed operation of the first bearing and the second bearing is effectively lowered, thus fulfilling a good silencing effect during high-speed rotation of the motor, and prolonging the service life of the fan motor, and satisfying actual use requirements of users; and the fan motor silent at a high speed is simple in structure, high in assembly precision and good in practicability and has outstanding substantive features and obvious improvements.

### BRIEF DESCRIPTION OF THE SEVERAL VIEWS OF THE DRAWINGS

FIG. 1 is an axonometric diagram according to one embodiment of the invention.

FIG. 2 is a schematic structural diagram of a terminal circuit board according to one embodiment of the invention.

FIG. 3 is a sectional view according to one embodiment of the invention.

FIG. 4 is a schematic structural diagram of a winding assembly in an unfolded state according to one embodiment of the invention.

FIG. 5 is a schematic structural diagram of outer iron cores in an unfolded state according to one embodiment of the invention.

FIG. 6 is a schematic structural diagram of a deformation portion according to one embodiment of the invention.

FIG. 7 is an assembled structural diagram of outer iron cores and inner iron cores according to one embodiment of the invention.

In the FIGS.:

1, casing; 2, rotor; 3, stator assembly; 4, bearing support; 5, first bearing; 6, second bearing; 7, inner iron core; 8, air duct; 9, impeller; 10, air guide vane; 11, winding assembly; 12, insulating support; 13, winding; 14, outer iron core; 15, positioning groove; 16, deformation portion; 17, deformation groove; 18, material-reduction groove; 19, pin; 20, terminal circuit board; 21, protection pillar; 22, limiting groove; 23, glue trough.

### DETAILED DESCRIPTION OF THE INVENTION

The embodiments of the invention are described in detail below in conjunction with accompanying drawings, but the invention may be implemented in many different ways defined and covered by the claims.

In the description of the invention, it should be understood that terms such as “central”, “longitudinal”. “transverse”, “length”, “width”, “thickness”, “upper end”, “lower end”, “front”, “back”, “left”, “right”. “vertical”, “horizontal”, “top”, “bottom”, “inner”, “outer”, “clockwise” and “anticlockwise” are used to indicate directional or positional relations based on the accompanying drawings merely for the purpose of facilitating and simplifying the description of the invention, do not indicate or imply that devices or elements referred to must be in a specific direction or be configured and operated in a specific direction, and thus should not be construed as limitations of the invention. In addition, terms “first” and “second” are merely for the purpose of description and should not be construed as indicating or implying relative importance or implicitly indicate the number of technical features referred to. Therefore, a feature defined by “first” or “second” may explicitly or implicitly indicate the inclusion of one or more said feature. In the description of the invention, “multiple” refers to two mor more, unless otherwise expressly and specifically defined.

In the description of the invention, it should be noted that unless otherwise expressly stated and defined, terms “mount”, “link” and “connect” should be understood in a broad sense. For example, “connect” may refer to fixed connection, detachable connection or integrated connection; mechanical connection or electrical connection; direction connection, indirect connection by means of an intermediate medium, or internal connection or interaction of two elements. Those ordinarily skilled in the art may appreciate the specific meanings of these terms in the invention as the case may be.

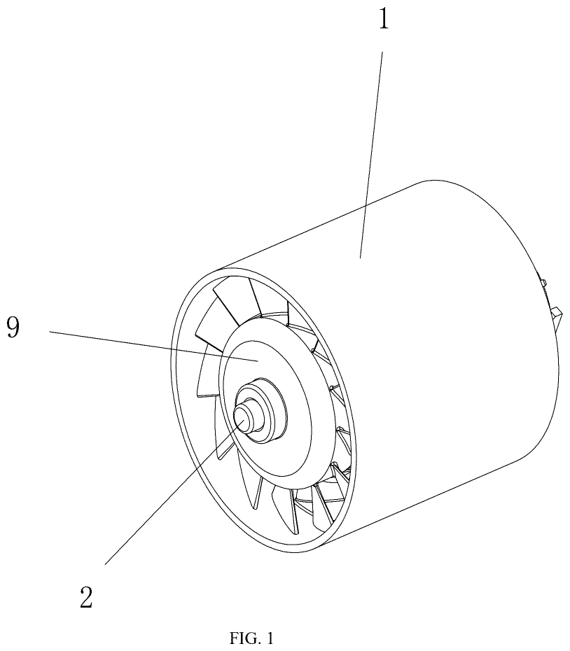

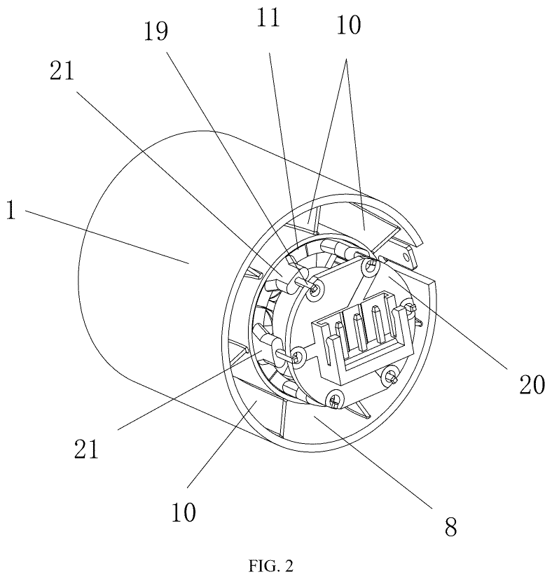

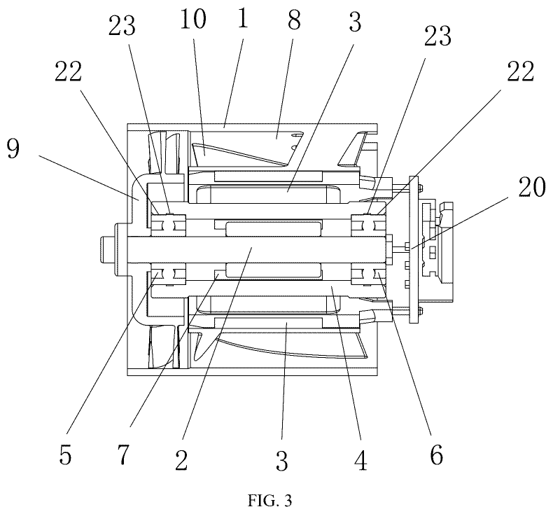

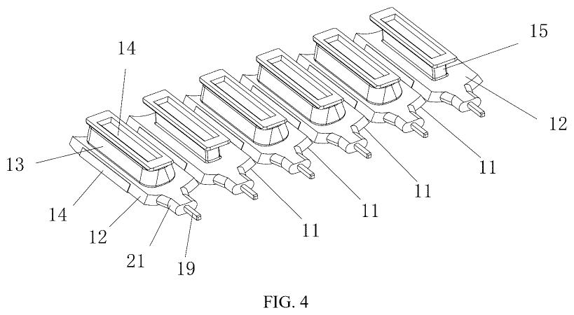

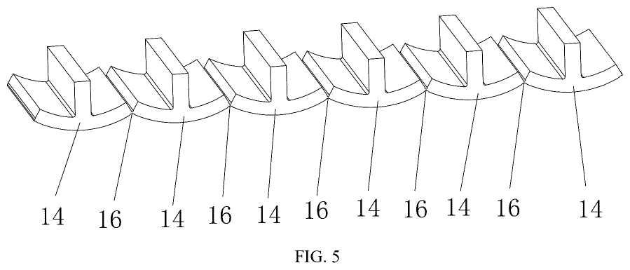

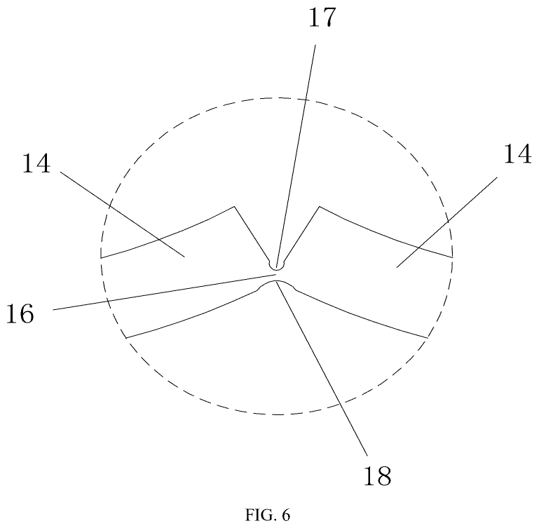

As shown in FIGS. 1-7, this embodiment provides a fan motor silent at a high speed, including a casing 1, a rotor 2, a stator assembly 3 and a hollow bearing support 4. The bearing support 4 is nested and fixed in an inner hole of the stator assembly 3, and the stator assembly 3 is nested and fixed in an inner cavity of the casing 1, so the stator assembly 3 and the bearing support 4 are sequentially and coaxially nested and fixed in the casing 1; a first bearing 5 and a second bearing 6 are coaxially mounted at two ends of the bearing support 4, inner iron cores 7 are inlaid in the bearing support 5 at intervals and injection-molded in the bearing support 6 by means of an insert mold, and two ends of the rotor 2 are rotatably inserted into inner holes of the first bearing 5 and the second bearing 6 respectively; and a through air duct 8 is arranged between an outer wall of the stator assembly 3 and an inner wall of the casing 1, an impeller 9 opposite to the air duct 8 in position is fixedly mounted at an exposed end of the rotor 2 and located in the casing 1, and air guide vanes 10 which are distributed in in an axial direction of the rotor 2 and incline in a same direction are arranged on an inner wall of the air duct 8 at intervals (as shown in FIGS. 1 and 2).

In the actual assembly process of the fan motor silent at a high speed in this embodiment, first, the rotor 2 is mounted in an inner cavity of the bearing support 4; then, the first bearing 5 and the second baring 6 are inserted and mounted in the two ends of the rotor 2 and coaxially and integrally mounted at the two ends of the bearing support 4; finally, the stator assembly 3 is fixed to the circumferential surface of the bearing support 4 with glue, and the impeller 9 is inserted and fixed to the exposed end of the rotor 2. In this way, the first bearing 5 and the second bearing 6 are integrally mounted on the bearing support 4, such that tolerances of the coaxiality and concentricity of the first bearing 5 and the second bearing 6 after installation are greatly reduced, and the installation accuracy of the first bearing 5 and the second bearing 6 is improved; the two ends of the rotor 2 are rotatably inserted into the inner holes of the first bearing 5 and the second bearing 6, the two ends of the rotor 2 are uniformly supported by the first bearing 5 and the second bearing 6, force borne by the first bearing 5 and the second bearing 6 is balanced, and the installation accuracy of the rotor 2 is high, such that the rotor 2 is always in a dynamic balance state during high-speed rotation, thus effectively reducing vibrations generated during high-speed rotation of the rotor 2 and lowering noise produced in operation of the fan motor; and the two ends of the rotor 2 are uniformly supported by the first bearing 5 and the second bearing 6 and force borne by the first bearing 5 and the second bearing 6 is balanced, such that a traditional installation structure of a cantilever beam of the rotor 2 is effectively avoided, force borne by the first bearing 5 and the second bearing 6 is uniform, and a radial force applied to the two bearings is effectively prevented during rotation of the rotor 2, thus greatly prolonging the service life of the first bearing 5 and the second bearing 6.

Further, in this embodiment, the stator assembly 3 includes at least two winding assemblies 11 which are connected and spliced in a circular shape. Each winding assembly 11 includes an arc-shaped insulating support 12, a winding 13 and an outer iron core 14, wherein the winding 13 is fixedly mounted on the insulating support 12, the outer iron core 14 is inlaid in the insulating support 12, and one end of the outer iron core 14 penetrates through an inner hole of the winding 13 and is exposed to an outer surface of the insulating support 12. Adjacent winding assemblies 11 may be horizontally unfolded from the circular shape to be in one row. During winding operation of the winding 13, a copper wire of the winding 13 is sequentially and horizontally rotated to be wound rather than being rotated from top to bottom to be inserted to be wound, such that the winding efficiency is greatly improved, and the winding time is shortened. After the copper wire of the winding 13 is wound, the winding assembly 11 is wound around the circumferential surface of the bearing support 4, such that the stator assembly 3 wraps the bearing support 4, and overall assembly of the stator assembly 3 is facilitated.

Further, in this embodiment, a positioning groove 15 used for mounting the winding 13 is formed in the insulating support 12. A copper wire is wound and limited in the positioning groove 15 and wound into the winding 13, such that manufacturing of the winding 13 is facilitated, and the winding 13 is effectively limited.

Further, in this embodiment, two ends of each inner iron core 7 are exposed to an inner wall and an outer surface of the bearing support 4, and one end of each outer iron core 14 is attached to one end of the corresponding inner iron core 7. Complete stator cores are formed by the outer iron cores 14 and the inner iron cores 7, and the inner iron cores 7 are inlaid in the bearing support 4 by an insert injection-molding process and may be automatically manufactured by means of a manipulator, such that the installation accuracy of the inner iron cores 7 in the bearing support 4 is greatly improved; and the inner iron cores 7 and the bearing support 4 are formed integrally, such that the number of assembled parts is effectively reduced, and the assembly efficiency is improved.

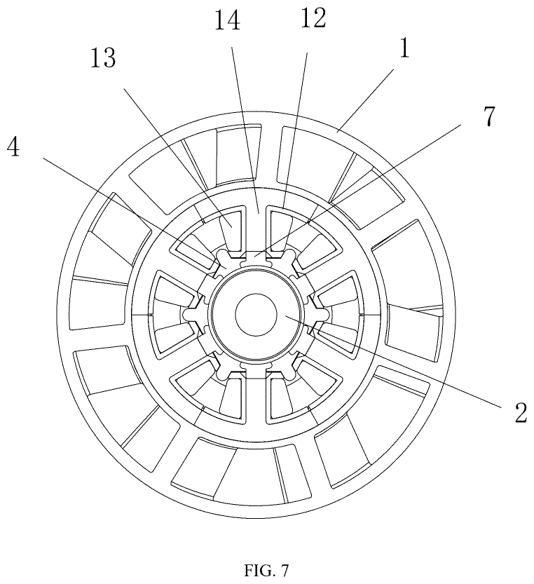

Further, in this embodiment, the outer iron cores 14 and the inner iron cores 7 are all T-shaped, and narrow ends of the outer iron cores 14 are attached to narrow ends of the inner iron cores 7 (as shown in FIG. 7). In this way, complete stator cores are formed by the outer iron cores 14 and the inner iron cores 7, and the T-shaped design of the inner iron cores allows wide ends of the inner iron cores 7 to be stably inlaid in the bearing support 4; moreover, the T-shaped design of the outer iron cores 14 allows wide ends of the outer iron cores 14 to be stably inlaid in the insulating support 12, such that the inlaying stability of the outer iron cores 14 and the inner iron cores 7 is effectively improved.

Further, in this embodiment, when adjacent outer iron cores 14 are horizontally unfolded, a deformation portion 16 is connected between every two adjacent outer iron cores 14, a deformation groove 17 and a material-reduction groove 18 are respectively formed in an upper end and a lower end of the deformation portion 16. In this way, when the adjacent outer iron cores 14 are wound to form a complete circle, the deformation portions 16 will be bent and deformed under the action of an external force; by means of the deformation grooves 17, bending interference of the two ends of the deformation portions 16 between the adjacent outer iron cores 14 may be effectively prevented when the adjacent outer iron cores 14 are bent, and the function of the deformation grooves 17 when the adjacent outer iron cores 14 are bent is similar to the function of a bending groove reserved when a metal plate is bent; and the material-reduction grooves 18 may effectively reduce the material area of the deformation portions 16, making the deformation portions 16 easier to bend and deform under the action of an external force.

Further, in this embodiment, a pin 19 electrically connected to the corresponding winding 13 is arranged at one end of the insulating support 12, and a terminal circuit board 20 is soldered to the pin 19. By means of the pin 19 and the terminal circuit board 20, users may supply power to the windings 13 easily, and actual electrical connection in use is facilitated for users.

Further, in this embodiment, a Y-shaped protection pillar 21 is arranged at one end of the insulating support 12, and one end of the pin 19 is inlaid in the protection pillar 21. The Y-shaped protection pillar 21 has a thick root and a thin tail end, thus being firm in overall structure. When the pin 19 is inlaid in the protection pillar 21, a lower end of the pin 19 is firmly fixed in the protection pillar 21, such that the firmness of the pin 19 is improved; moreover, because the voltage and current across the pins are large and the pins closed to each other, the protection pillar 21 is made from an insulating material to effectively prevent short circuits or electric arcs between the pins.

Further, in this embodiment, limiting grooves 22 are coaxially formed in the two ends of the bearing support 4, the first bearing 5 and the second bearing 6 are fixedly mounted in the limiting grooves 22 with glue. By means of the limiting grooves 22, the first bearing 5 and the second bearing 6 may be stably limited and mounted; moreover, if the two limiting grooves 22 have a higher concentricity requirement, the bearing support 4 may be mounted on a machine tool to realize more precise machining of the two limiting grooves 22 to further improve the concentricity of the two limiting grooves 22.

Further, in this embodiment, the bearing support 4 and the inner iron cores 7 are integrally formed by injection molding with a mold, and the two limiting grooves 22 are formed synchronously after injection molding with the mold. In this way, the concentricity of the two limiting grooves 22 is guaranteed, and the concentricity of a center line formed by the two limiting grooves 22 and the inner iron cores 7 is effectively improved, thus greatly improving the manufacturing precision of the stator assembly and effectively improving the assembly precision of the rotor 2 and the stator assembly 3.

Further, in this embodiment, glue troughs 23 are arranged in the limiting grooves 22. In this way, when the first bearing 5 and the second bearing 6 are fixedly mounted in the limiting grooves 22 with glue, a certain quantity of glue may be stored in the glue troughs 23, thus effectively improving the gluing firmness of the first bearing 5 and the second bearing 6.

The above embodiments are merely preferred ones of the invention and are not intended to limit the patent scope of the invention. All equivalent structural or flow transformations made based on the contents in the specification and drawings, or direct or indirect applications to other related technical fields should also fall within the patent protection scope of the invention.

What is claimed is:

1. A fan motor silent at a high speed, comprising a casing, a rotor, a stator assembly and a hollow bearing support, wherein the stator assembly and the bearing support are sequentially and coaxially nested and fixed in the casing, a first bearing and a second bearing are coaxially mounted at two ends of the bearing support, inner iron cores are inlaid in the bearing support at intervals, two ends of the rotor are rotatably inserted into inner holes of the first bearing and the second bearing respectively, a through air duct is arranged between an outer wall of the stator assembly and an inner wall of the casing, an impeller opposite to the air duct in position is fixedly mounted at an exposed end of the rotor and located in the casing, and air guide vanes which are distributed in an axial direction of the rotor and incline in a same direction are arranged on an inner wall of the air duct at intervals.

2. The fan motor silent at a high speed according to claim 1, wherein the stator assembly comprises at least two winding assemblies which are connected and spliced in a circular shape; and each said winding assembly comprises an arc-shaped insulating support, a winding and an outer iron core, the winding is fixedly mounted on the insulating support, the outer iron core is inlaid in the insulating support, and the outer iron core has an end penetrating through an inner hole of the winding and exposed to an outer surface of the insulating support.

3. The fan motor silent at a high speed according to claim 2, wherein a positioning groove used for mounting the winding is formed in the insulating support.

4. The fan motor silent at a high speed according to claim 2, wherein each said inner iron core has two ends exposed to an inner wall and an outer surface of the bearing support, and the outer iron core has an end attached to one end of the corresponding inner iron core.

5. The fan motor silent at a high speed according to claim 2, wherein the outer iron cores and the inner iron cores are all T-shaped, and narrow ends of the outer iron cores are attached to narrow ends of the inner iron cores.

6. The fan motor silent at a high speed according to claim 2, wherein a deformation portion is connected between every two adjacent said outer iron cores, and a deformation groove and a material-reduction groove are formed in an upper end and a lower end of the deformation portion respectively.

7. The fan motor silent at a high speed according to claim 2, wherein a pin electrically connected to the winding is arranged at an end of the insulating support, and a terminal circuit board is soldered to the pin.

8. The fan motor silent at a high speed according to claim 7, wherein a Y-shaped protection pillar is arranged at an end of the insulating support, and an end of the pin is inlaid in the protection pillar.

9. The fan motor silent at a high speed according to claim 1, wherein limiting grooves are coaxially formed in two ends of the bearing support, and the first bearing and the second bearing are fixedly mounted in the limiting grooves with glue.

10. The fan motor silent at a high speed according to claim 9, wherein the bearing support and the inner iron core are formed integrally by injection molding with a mold, and the two limiting grooves are formed synchronously after injection molding with the mold.
